(19) United States
(12) Patent Application Publication
(10) Pub. No.: US 2026/0209560 A1
(43) Pub. Date: Jul. 23, 2026

(54) PRIMERLESS SELF-ADHERABLE ROOFING ACCESSORIES AND RELATED SYSTEMS AND METHODS

(71) Applicant: BMIC LLC, Dallas, TX (US)

(72) Inventors: Chunjuan Sheng, Mountain Lakes, NJ (US); Michael I. Cukrow, Lake Hiawatha, NJ (US)

(21) Appl. No.: 19/454,589

(22) Filed: Jan. 21, 2026

Related U.S. Application Data
(60) Provisional application No. 63/817,453, filed on Jun. 4, 2025.
(60) Provisional application No. 63/748,109, filed on Jan. 22, 2025.

(51) Int. Cl. C09J 7/22; C09J 7/30; E04D 13/14; C09J 123/22

(52) U.S. Cl. CPC C09J 7/22; C09J 7/30; E04D 13/14; C09J 123/22; C09J 2203/346

(57) ABSTRACT

This invention, in embodiments, relates to a primerless self-adhered roofing accessory comprising a substrate having an upper surface and a lower surface, with at least one of the upper surface or the lower surface of the substrate including an adhesive material. In one embodiment, the primerless self-adhered roofing accessory is configured to be installed onto a roofing substrate without the use of a primer. This invention, in embodiments, further relates to a method of preparing a primerless self-adhered roofing accessory, as well as a method of installing a primerless self-adhered roofing accessory onto a roofing substrate.

### CROSS REFERENCE TO RELATED APPLICATIONS

This application claims the priority of U.S. provisional application Ser. No. U.S. 63/748,109 entitled "Primerless Self-Adherable Roofing Accessories and Related Systems and Methods" filed January 22, 2025, and U.S. provisional application Ser. No. U.S. 63/817,453 entitled "Primerless Self-Adherable Roofing Accessories and Related Systems and Methods" filed June 4, 2025, which are incorporated herein by reference in their entireties for all purposes.

### FIELD OF THE INVENTION

This invention generally relates to primerless self-adherable roofing accessories, and related systems and methods.

### BACKGROUND OF THE INVENTION

Roofing accessories may be installed on roofing systems to prevent water penetration into an underlying building structure. Conventional self-adhered roofing accessories generally require the application of a primer on the adhered substrate during application.

### SUMMARY OF THE INVENTION

One embodiment of this invention pertains to a primerless self-adhered roofing accessory comprising a substrate having an upper surface and a lower surface. In one embodiment, at least one of the upper surface or the lower surface of the substrate includes an adhesive material. In one embodiment, the primerless self-adhered roofing accessory is configured to be installed onto a roofing substrate without the use of a primer.

In one embodiment, the adhesive material is configured to directly adhere the primerless self-adhered roofing accessory to the roofing substrate.

In one embodiment, the lower surface of the substrate includes the adhesive material. In one embodiment, the upper surface of the substrate includes the adhesive material. In one embodiment, both the lower surface and the upper surface of the substrate includes the adhesive material.

In one embodiment, the adhesive material comprises a butyl-based adhesive.

In one embodiment, the adhesive material is covered by a release layer.

In one embodiment, the substrate comprises a facer material.

In one embodiment, the substrate is injection molded. In one embodiment, the substrate comprises a thermoformed part.

In one embodiment, the substrate comprises at least one of thermoplastic polyolefin (TPO), ethylene propylene diene monomer (EPDM), thermoplastic vulcanizates (TPV), polyvinyl chloride (PVC), or a combination thereof. In one embodiment, the substrate comprises TPO.

In one embodiment, the roofing substrate comprises at least one of TPO, EPDM, PVC, metal, or a combination thereof. In one embodiment, the roofing substrate comprises a PVC pipe. In one embodiment, the roofing substrate comprises a coated edge metal.

In one embodiment, the primerless self-adhered roofing accessory comprises a cover tape. In another embodiment, the primerless self-adhered roofing accessory comprises a TPO cover tape.

In one embodiment, the primerless self-adhered roofing accessory comprises at least one of an edge metal cover tape, a heat weldable cover tape, flashing (including, e.g., EPDM flashing), a T-joint patch, a corner patch, a premolded corner, a vent boot, a pourable sealant pocket, a repair patch, a tube wrap, a bare metal scupper, a safety tape, an adhesive tape, a drain, a cover tape, a flashing roll, a solar mount, or a combination thereof.

In one embodiment, the primerless self-adhered roofing accessory comprises a solar mount. In one embodiment, the solar mount comprises a TPO solar mount (or TPO anchor). According to one embodiment, the solar mount comprises a plate having a cover membrane. In one embodiment, the cover membrane is sealed to an upper surface of the plate.

In one embodiment, the primerless self-adhered roofing accessory comprises flashing. In one embodiment, the primerless self-adhered roofing accessory comprises at least one of TPO flashing, EPDM flashing, or a combination thereof.

Another embodiment of this invention pertains to a roofing system that includes a roofing substrate and a primerless self-adhered roofing accessory attached to the roofing substrate. In one embodiment, the primerless self-adhered roofing accessory comprises a substrate having an upper surface and a lower surface, with at least one of the upper surface or the lower surface of the substrate including an adhesive material. In one embodiment, the adhesive material is directly adhered to an upper surface of the roofing substrate. In another embodiment, the roofing system does not include a primer layer located between the adhesive material of the primerless self-adhered roofing accessory and the upper surface of the roofing substrate.

In one embodiment, the primerless self-adhered roofing accessory is attached to the roofing substrate without the use of a primer.

In one embodiment, the roofing substrate comprises an unprimed surface.

In one embodiment, the roofing substrate includes a roofing penetration. In one embodiment, the adhesive material is directly adhered to the roofing penetration.

In one embodiment, the lower surface of the substrate includes the adhesive material. In one embodiment, the upper surface of the substrate includes the adhesive material. In one embodiment, both the lower surface and the upper surface of the substrate includes the adhesive material.

In one embodiment, the adhesive material comprises a butyl-based adhesive.

In one embodiment, the substrate comprises a facer material.

In one embodiment, the substrate is injection molded. In one embodiment, the substrate comprises a thermoformed part.

In one embodiment, the substrate comprises at least one of thermoplastic polyolefin (TPO), ethylene propylene diene monomer (EPDM), thermoplastic vulcanizates (TPV), polyvinyl chloride (PVC), or a combination thereof. In one embodiment, the substrate comprises TPO.

In one embodiment, the roofing substrate comprises at least one of TPO, EPDM, PVC, metal, or a combination thereof. In one embodiment, the roofing substrate comprises a PVC pipe. In one embodiment, the roofing substrate comprises a coated edge metal.

In one embodiment, the primerless self-adhered roofing accessory comprises a cover tape. In another embodiment, the primerless self-adhered roofing accessory comprises a TPO cover tape.

In one embodiment, the primerless self-adhered roofing accessory comprises at least one of an edge metal cover tape, a heat weldable cover tape, flashing (including, e.g., EPDM flashing), a T-joint patch, a corner patch, a premolded corner, a vent boot, a pourable sealant pocket, a repair patch, a tube wrap, a bare metal scupper, a safety tape, an adhesive tape, a drain, a cover tape, a flashing roll, a solar mount, or a combination thereof.

In one embodiment, the primerless self-adhered roofing accessory comprises a solar mount. In one embodiment, the solar mount comprises a TPO solar mount (or TPO anchor). According to one embodiment, the solar mount comprises a plate having a cover membrane. In one embodiment, the cover membrane is sealed to an upper surface of the plate.

In one embodiment, the primerless self-adhered roofing accessory comprises flashing. In one embodiment, the primerless self-adhered roofing accessory comprises at least one of TPO flashing, EPDM flashing, or a combination thereof.

Another embodiment of the invention pertains to a method of preparing a primerless self-adhered roofing accessory that includes obtaining a substrate, obtaining an adhesive material, and applying the adhesive material to a surface of the substrate to prepare the primerless self-adhered roofing accessory. In one embodiment, the primerless self-adhered roofing accessory is configured to be installed onto a roofing substrate without the use of a primer.

In one embodiment, the adhesive material is configured to directly adhere the primerless self-adhered roofing accessory to a roofing substrate.

In one embodiment, the applying the adhesive material to a surface of the substrate is conducted prior to installation of the primerless self-adhered roofing accessory onto a roofing substrate.

In one embodiment, the adhesive material is applied to a lower surface of the substrate. In one embodiment, the adhesive material is applied to an upper surface of the substrate. In one embodiment, the adhesive material is applied to both a lower surface and an upper surface of the substrate.

In one embodiment, the adhesive material comprises a butyl-based adhesive.

In one embodiment, the method further comprises applying a release layer onto the adhesive material, to thereby cover the adhesive material with the release layer.

In one embodiment, the substrate comprises a facer material.

In one embodiment, the substrate is injection molded. In one embodiment, the substrate comprises a thermoformed part.

In one embodiment, the substrate comprises at least one of thermoplastic polyolefin (TPO), ethylene propylene diene monomer (EPDM), thermoplastic vulcanizates (TPV), polyvinyl chloride (PVC), or a combination thereof. In one embodiment, the substrate comprises TPO.

In one embodiment, the roofing substrate comprises at least one of TPO, EPDM, PVC, metal, or a combination thereof. In one embodiment, the roofing substrate comprises a PVC pipe. In one embodiment, the roofing substrate comprises a coated edge metal.

In one embodiment, the primerless self-adhered roofing accessory comprises a cover tape. In another embodiment, the primerless self-adhered roofing accessory comprises a TPO cover tape.

In one embodiment, the primerless self-adhered roofing accessory comprises at least one of an edge metal cover tape, a heat weldable cover tape, flashing (including, e.g., EPDM flashing), a T-joint patch, a corner patch, a premolded corner, a vent boot, a pourable sealant pocket, a repair patch, a tube wrap, a bare metal scupper, a safety tape, an adhesive tape, a drain, a cover tape, a flashing roll, a solar mount, or a combination thereof.

In one embodiment, the primerless self-adhered roofing accessory comprises a solar mount. In one embodiment, the solar mount comprises a TPO solar mount (or TPO anchor). According to one embodiment, the solar mount comprises a plate having a cover membrane. In one embodiment, the cover membrane is sealed to an upper surface of the plate.

In one embodiment, the primerless self-adhered roofing accessory comprises flashing. In one embodiment, the primerless self-adhered roofing accessory comprises at least one of TPO flashing, EPDM flashing, or a combination thereof.

Yet another embodiment of this invention pertains to a method of installing at least one primerless self-adhered roofing accessory onto a roofing substrate that includes obtaining at least one primerless self-adhered roofing accessory, with the at least one primerless self- adhered roofing accessory comprising a substrate having an upper surface and a lower surface, with at least one of the upper surface or the lower surface of the substrate including an adhesive material, and applying the at least one primerless self-adhered roofing accessory to the roofing substrate. In one embodiment, the adhesive material is directly adhered to an upper surface of the roofing substrate.

In one embodiment, the applying the at least one primerless self-adhered roofing accessory to the roofing substrate is conducted without the use of a primer.

In one embodiment, the method further comprises removing a release layer covering the adhesive material to thereby expose the adhesive material, prior to applying the at least one primerless self-adhered roofing accessory to the roofing substrate.

In one embodiment, the lower surface of the substrate includes the adhesive material. In one embodiment, the upper surface of the substrate includes the adhesive material. In one embodiment, both the lower surface and the upper surface of the substrate includes the adhesive material.

In one embodiment, the adhesive material comprises a butyl-based adhesive.

In one embodiment, the substrate comprises a facer material.

In one embodiment, the substrate is injection molded. In one embodiment, the substrate comprises a thermoformed part.

In one embodiment, the substrate comprises at least one of thermoplastic polyolefin (TPO), ethylene propylene diene monomer (EPDM), thermoplastic vulcanizates (TPV), polyvinyl chloride (PVC), or a combination thereof. In one embodiment, the substrate comprises TPO.

In one embodiment, the roofing substrate includes a roofing penetration. In one embodiment, the adhesive material is directly adhered to the roofing penetration.

In one embodiment, the roofing substrate comprises at least one of TPO, EPDM, PVC, metal, or a combination thereof. In one embodiment, the roofing substrate comprises a PVC pipe. In one embodiment, the roofing substrate comprises a coated edge metal.

In one embodiment, the primerless self-adhered roofing accessory comprises a cover tape. In another embodiment, the primerless self-adhered roofing accessory comprises a TPO cover tape.

In one embodiment, the primerless self-adhered roofing accessory comprises at least one of an edge metal cover tape, a heat weldable cover tape, flashing (including, e.g., EPDM flashing), a T-joint patch, a corner patch, a premolded corner, a vent boot, a pourable sealant pocket, a repair patch, a tube wrap, a bare metal scupper, a safety tape, an adhesive tape, a drain, a cover tape, a flashing roll, a solar mount, or a combination thereof.

In one embodiment, the primerless self-adhered roofing accessory comprises a solar mount. In one embodiment, the solar mount comprises a TPO solar mount (or TPO anchor). According to one embodiment, the solar mount comprises a plate having a cover membrane. In one embodiment, the cover membrane is sealed to an upper surface of the plate.

In one embodiment, the primerless self-adhered roofing accessory comprises flashing. In one embodiment, the primerless self-adhered roofing accessory comprises at least one of TPO flashing, EPDM flashing, or a combination thereof.

Another embodiment of this invention pertains to a bundle of primerless self-adhered roofing accessories that includes a plurality of primerless self-adhered roofing accessories, with each primerless self-adhered roofing accessory of the plurality of primerless self-adhered roofing accessories comprising a substrate having an upper surface and a lower surface, with at least one of the upper surface or the lower surface of the substrate including an adhesive material. In one embodiment, each primerless self-adhered roofing accessory of the plurality of primerless self-adhered roofing accessories is configured to be installed onto a roofing substrate without the use of a primer.

### BRIEF DESCRIPTION OF THE FIGURES

For a more complete understanding of the invention and the advantages thereof, reference is made to the following descriptions, taken in conjunction with the accompanying figures, in which:

FIG. 1 is an illustration of a primerless self-adhered roofing accessory according to an embodiment of the invention.

FIG. 2 is an illustration of a primerless self-adhered roofing accessory according to an embodiment of the invention.

FIG. 3 is an illustration of a roofing system according to an embodiment of the invention.

FIG. 4 is an illustration of a roofing system according to an embodiment of the invention.

FIG. 5 is a flowchart illustrating a method of preparing a primerless self-adhered roofing accessory according to an embodiment of the invention.

FIG. 6 is a flowchart illustrating a method of installing a primerless self-adhered roofing accessory according to an embodiment of the invention.

FIG. 7 is an illustration of a primerless self-adhered roofing accessory according to an embodiment of the invention.

### DETAILED DESCRIPTION OF THE INVENTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases "in one embodiment," "in an embodiment," and "in some embodiments" as used herein do not necessarily refer to the same embodiment(s), though they may. Furthermore, the phrases "in another embodiment" and "in some other embodiments" as used herein do not necessarily refer to a different embodiment, although they may. All embodiments of the disclosure are intended to be combinable without departing from the scope or spirit of the disclosure.

As used herein, the term "based on" is not exclusive and allows for being based on additional factors not described, unless the context clearly dictates otherwise. In addition, throughout the specification, the meaning of "a," "an," and "the" include plural references. The meaning of "in" includes "in" and "on."

As used herein, terms such as "comprising," "including," and "having" do not limit the scope of a specific claim to the materials or steps recited by the claim.

As used herein, terms such as "consisting of" limit the scope of a specific claim to the materials and steps recited by the claim.

All prior patents, publications, and test methods referenced herein are incorporated by reference in their entireties.

As used herein, the term "roofing substrate" includes, but is not limited to, a substrate, a penetration or roofing penetration (e.g., a roof boot and/or a PVC pipe), a support layer, a structure, an asphaltic substrate, a plywood substrate, a glass substrate, a cellulosic substrate, an underlayment, a liquid applied membrane, a roofing shingle, a roofing membrane (reinforced or unreinforced, e.g., TPO membrane, PVC membrane, EPDM membrane, etc.), a roofing accessory, an edge metal (including, e.g., a coated edge metal), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a high density cover board, a cement board, concrete, a base sheet, a pipe, a chimney, a wax paper, flashing, a mesh, a fleece, a mat, a fabric, a glass mat, a fiberglass mat, a woven mat, a nonwoven mat, a polyester mat, a scrim, a coated scrim, a spunbond mat, a spunlaced mat, an airlaid mat, a meltblown mat, a woven fabric, a non-woven fabric, a metal foil, or any combination thereof.

As used herein, the term "primer" refers to a substance located between an adhesive and a surface. The term "primer layer" refers to a layer comprising a primer, wherein the layer is located between an adhesive and a surface. In some embodiments, the substance comprises a non-volatile substance. In some embodiments, the substance comprises a non-volatile substance which is not present in a solvent, such as, for example and without limitation, a solvent for cleaning a surface (e.g., a cleaning solvent). In some embodiments, the primer comprises a nonvolatile substance and a volatile substance. In some embodiments, the terms "primer" and "primer layer" do not refer to a solvent (e.g., a cleaning solvent). Non-limiting examples of primers include, for example and without limitation, at least one of an epoxy primer, an acrylic primer, a polyurethane primer, or any combination thereof.

As used herein, the term "unprimed surface" refers to a surface that is free of primer (e.g., a primer is not present on the surface). In some embodiments, an unprimed surface is a solvent-cleaned surface. For example, in some embodiments, the unprimed surface is contacted with a solvent (e.g., a cleaning solvent). Non-limiting examples of cleaning solvents include, without limitation, at least one of isopropyl alcohol, acetone, or any combination thereof, and the like.

This invention relates to primerless self-adhered roofing accessories. Generally, conventional self-adhered roofing accessories usually require the application or use of a primer on the adhered substrate during application, in order to achieve proper adhesion to the substrate. This invention, in embodiments, describes various applications in which a primerless self-adhered solution is provided through the use of innovative primerless self-adhered roofing accessories. According to embodiments described herein, the primerless self-adhered roofing accessories provide labor and/or time savings by removing the priming step and still achieve a comparable adhesion as well as weatherability.

One embodiment of this invention pertains to a primerless self-adhered roofing accessory comprising a substrate having an upper surface and a lower surface. In one embodiment, at least one of the upper surface or the lower surface of the substrate includes an adhesive material. In one embodiment, the primerless self-adhered roofing accessory is configured to be installed onto a roofing substrate without the use of a primer.

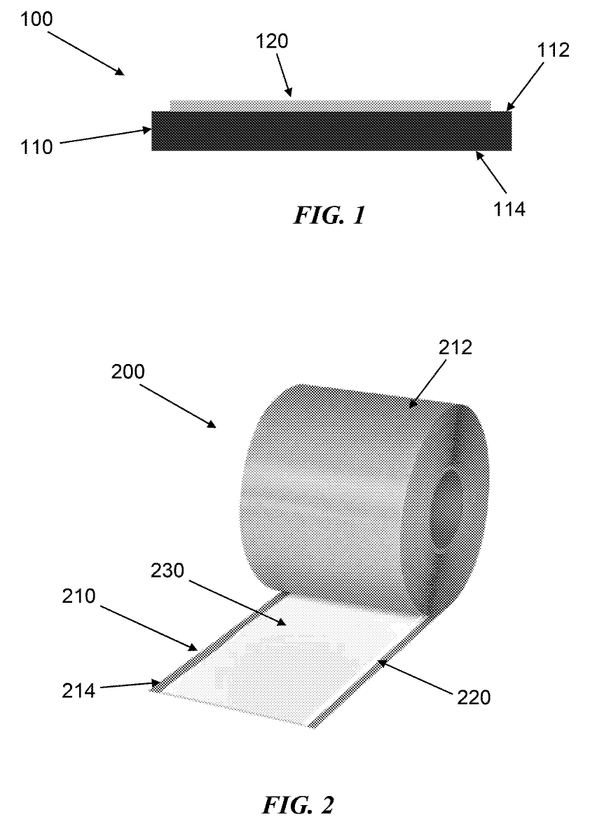

For example, FIG. 1 is an illustration of a primerless self-adhered roofing accessory according to an embodiment of the invention. As shown in FIG. 1, the primerless self-adhered roofing accessory 100 comprises a substrate 110 having an upper surface 112 and a lower surface 114, with an adhesive material 120 applied to at least the upper surface 112 of the substrate 110.

FIG. 2 is another illustration of a primerless self-adhered roofing accessory according to an embodiment of the invention. As shown in FIG. 2, the primerless self-adhered roofing accessory 200, which is in the form of a cover tape (e.g., a TPO cover tape), comprises a substrate 210 having an upper surface 212 and a lower surface 214, with an adhesive material 220 applied to at least the lower surface 214 of the substrate 210. As further shown in FIG. 2, a release layer 230 is provided that covers the adhesive material 220 prior to the use and/or application of the primerless self-adhered roofing accessory 200 to a roofing substrate. According to embodiments described herein, the release layer 230 is removed prior to applying and/or adhering the adhesive material 220 of the primerless self-adhered roofing accessory 200 to a roofing substrate.

In one embodiment, the adhesive material is configured to directly adhere the primerless self-adhered roofing accessory to the roofing substrate.

In one embodiment, the lower surface of the substrate includes the adhesive material. In one embodiment, the upper surface of the substrate includes the adhesive material. In one embodiment, both the lower surface and the upper surface of the substrate includes the adhesive material.

In one embodiment, the adhesive material comprises a butyl-based adhesive.

In one embodiment, the adhesive material is covered by a release layer (see, e.g., FIG. 2).

In one embodiment, the substrate comprises a facer material (see, e.g., FIG. 1).

In one embodiment, the substrate is injection molded. In one embodiment, the substrate comprises a thermoformed part.

In one embodiment, the substrate comprises at least one of thermoplastic polyolefin (TPO), ethylene propylene diene monomer (EPDM), thermoplastic vulcanizates (TPV), polyvinyl chloride (PVC), or a combination thereof. In one embodiment, the substrate comprises TPO.

In one embodiment, the roofing substrate comprises an unprimed surface.

In one embodiment, the roofing substrate (or the substrate to be adhered to and/or the roofing system material) comprises at least one of TPO, EPDM, PVC (including, e.g., rigid PVC such as, e.g., a PVC pipe), metal (such as, e.g., aluminum, galvanized or Kynar coated edge metal), or a combination thereof. In one embodiment, the roofing substrate comprises a PVC pipe. In one embodiment, the roofing substrate comprises a coated edge metal.

In one embodiment, the primerless self-adhered roofing accessory comprises a cover tape (see, e.g., FIG. 2). In another embodiment, the primerless self-adhered roofing accessory comprises a TPO cover tape.

In one embodiment, the primerless self-adhered roofing accessory comprises at least one of an edge metal cover tape (e.g., adhesive tape that covers the full width of the substrate or facer material, usually 6" wide, 100' long), a heat weldable cover tape (e.g., adhesive tape that covers only half of the width of the substrate or facer material, usually 6" wide, 100' long), flashing (including, e.g., EPDM flashing) or a flashing roll (e.g., a stretchable substrate or facer material with full adhesive tape coverage, usually used for finishing complex details, with e.g., a variable width at 6", 9", 12", 18". 50' or 100' long), a T-joint patch (e.g., round or square patches with full adhesive tape coverage, with, e.g., a variable diameter/length at 4" to 7"), a corner patch (e.g., an inside/outside corner patch that includes round or rectangular patches with full adhesive tape coverage, with, e.g., a diameter/length at 6" to 9"), a premolded corner (e.g., an inside/outside corner comprising injection molded or thermoformed corner parts with full or partial adhesive tape coverage), a vent boot (e.g., a premolded and/or injection molded vent boot with adhesive tape on bottom flange), a pourable sealant pocket (e.g., a premolded and/or injection molded pocket (either one piece or a split pocket), with adhesive tape on bottom flange), a repair patch (e.g., an inside/outside corner patch that includes round or rectangular patches with full adhesive tape coverage, with, e.g., a diameter/length at 6" to 9"), a tube wrap (e.g., a square or conical tube wrap that is usually field fabricated using flashing rolls), a bare metal scupper (e.g., usually field fabricated using flashing rolls), a safety tape (e.g., a substrate or facer that is designed to be easily visualized or a stand-out color, such as, e.g., bright yellow), an adhesive tape, a drain (e.g., an adhesive tape at the flange for waterproofing), a cover tape, a solar mount, or a combination thereof.

In one embodiment, the primerless self-adhered roofing accessory comprises flashing. In one embodiment, the primerless self-adhered roofing accessory comprises at least one of TPO flashing, EPDM flashing, or a combination thereof.

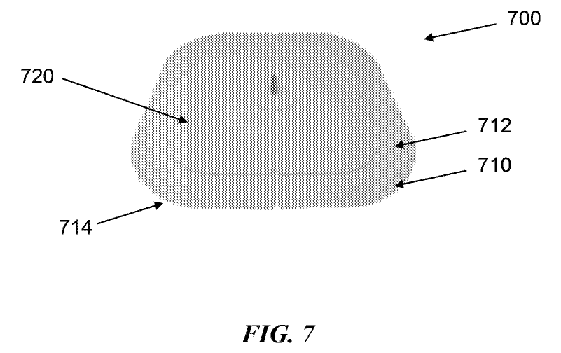

In one embodiment, the primerless self-adhered roofing accessory comprises a solar mount, such as, e.g., a TPO solar mount (or TPO anchor). For example, FIG. 7 is an illustration of a primerless self-adhered roofing accessory according to another embodiment of the invention. As shown in FIG. 7, the primerless self-adhered roofing accessory 700, which is in the form of a solar mount (e.g., a TPO solar mount or anchor), comprises a substrate 710 (or plate) having an upper surface 712 and a lower surface 714, with an adhesive material (not shown) applied to at least the lower surface 714 of the substrate 710. As further shown in FIG. 7, the primerless self-adhered roofing accessory 700, which is in the form of a solar mount, includes a cover membrane 720 that is attached to and/or sealed to the upper surface 712 of the substrate 710 (or plate). The primerless self-adhered roofing accessory 700, which is in the form of a solar mount, is configured to be applied and/or adhered to a roofing substrate via the adhesive material (not shown) applied to at least the lower surface 714 of the substrate 710 (or plate). According to embodiments described herein, the primerless self-adhered roofing accessory 700 of FIG. 7, which is in the form of a solar mount, provides a watertight attachment to securely mount roofing equipment, such as, e.g., solar panels, to a roofing substrate (such as, e.g., TPO membranes). According to one embodiment, the primerless self- adhered roofing accessory 700 of FIG. 7, which is in the form of a solar mount, is applied and/or adhered to a roofing substrate via the adhesive material (not shown) applied to at least the lower surface 714 of the substrate 710 (or plate), with or without the inclusion of additional fasteners, and without the use of a primer. Thereafter, the cover membrane 720 can be welded (e.g., hot air welded) around its perimeter to the roofing substrate.

Another embodiment of this invention pertains to a roofing system that includes a roofing substrate and a primerless self-adhered roofing accessory attached to the roofing substrate. In one embodiment, the primerless self-adhered roofing accessory comprises a substrate having an upper surface and a lower surface, with at least one of the upper surface or the lower surface of the substrate including an adhesive material. In one embodiment, the adhesive material is directly adhered to an upper surface of the roofing substrate. In another embodiment, the roofing system does not include a primer layer located between the adhesive material of the primerless self-adhered roofing accessory and the upper surface of the roofing substrate.

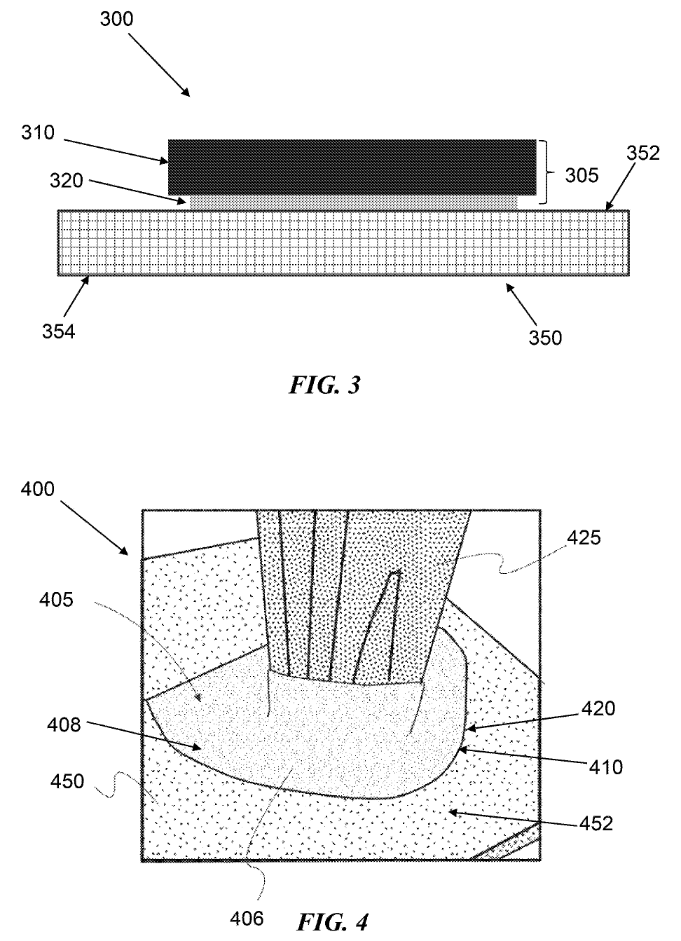

For example, FIG. 3 is an illustration of a roofing system that includes a primerless self-adhered roofing accessory according to an embodiment of the invention. As shown in FIG. 3, the roofing system 300 includes a roofing substrate 350 having an upper surface 352 and a lower surface 354, with a primerless self-adhered roofing accessory 305 attached to the upper surface 352 of the roofing substrate 350. As further shown in FIG. 3, the primerless self- adhered roofing accessory 305 comprises a substrate 310 having an adhesive material 320 applied to a surface of the substrate 310. Thus, as shown in the embodiment of the roofing system 300 of FIG. 3, the adhesive material 320 is directly adhered to the upper surface 352 of the roofing substrate 350. Accordingly, as further shown in the embodiment of the roofing system 300 of FIG. 3, the roofing system 300 does not include a primer layer located between the adhesive material 320 of the primerless self-adhered roofing accessory 305 and the upper surface 352 of the roofing substrate 350.

In one embodiment, the primerless self-adhered roofing accessory is attached to the roofing substrate without the use of a primer.

In one embodiment, the roofing substrate comprises an unprimed surface.

In one embodiment, the roofing substrate includes a roofing penetration. In one embodiment, the adhesive material is directly adhered to the roofing penetration.

For example, FIG. 4 is an illustration of a roofing system that includes a primerless self-adhered roofing accessory and a roofing penetration according to an embodiment of the invention. As shown in FIG. 4, the roofing system 400 includes a roofing substrate 450 having an upper surface 452, with a roofing penetration 425 extending from the upper surface 452 of the roofing substrate 450. As further shown in FIG. 4, a primerless self-adhered roofing accessory 405 is attached to the upper surface 452 of the roofing substrate 450, as well as the roofing penetration 425, with the primerless self-adhered roofing accessory 405 comprising a substrate 406 having an upper surface 408 and a lower surface 410, wherein an adhesive material 420 is applied to the lower surface 410 of the substrate 406. Thus, as shown in the embodiment of the roofing system 400 of FIG. 4, the adhesive material 420 is directly adhered to the upper surface 452 of the roofing substrate 450, as well as the roofing penetration 425. Accordingly, as further shown in the embodiment of the roofing system 400 of FIG. 4, the roofing system 400 does not include a primer layer located between the adhesive material 420 of the primerless self-adhered roofing accessory 405 and the upper surface 452 of the roofing substrate 450, as well as the roofing penetration 425.

In one embodiment, the lower surface of the substrate includes the adhesive material. In one embodiment, the upper surface of the substrate includes the adhesive material. In one embodiment, both the lower surface and the upper surface of the substrate includes the adhesive material.

Another embodiment of the invention pertains to a method of preparing a primerless self-adhered roofing accessory that includes obtaining a substrate, obtaining an adhesive material, and applying the adhesive material to a surface of the substrate to prepare the primerless self-adhered roofing accessory. In one embodiment, the primerless self-adhered roofing accessory is configured to be installed onto a roofing substrate without the use of a primer.

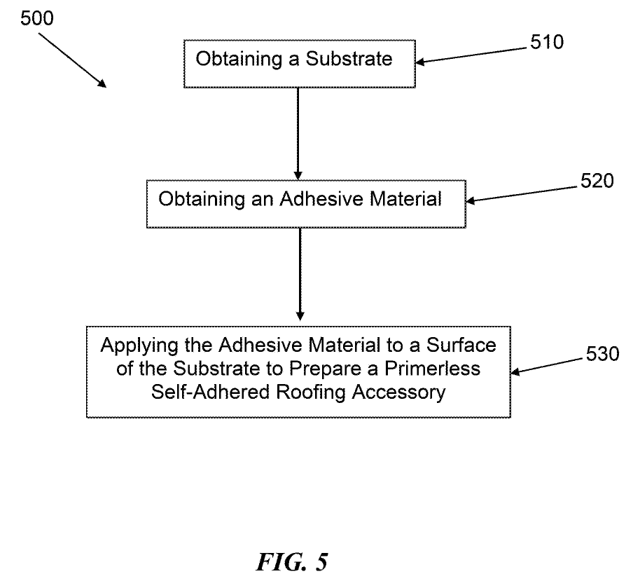

For example, FIG. 5 is a flowchart illustrating a method of preparing a primerless self- adhered roofing accessory according to an embodiment of the invention. As shown in FIG. 5, the method 500 of preparing a primerless self-adhered roofing accessory includes a step 510 of obtaining a substrate, a step 520 of obtaining an adhesive material, and a step 530 of applying the adhesive material to a surface of the substrate to prepare the primerless self-adhered roofing accessory.

In one embodiment, the adhesive material is configured to directly adhere the primerless self-adhered roofing accessory to a roofing substrate (see, e.g., FIGS. 3 and 4).

In one embodiment, the applying the adhesive material to a surface of the substrate is conducted prior to installation of the primerless self-adhered roofing accessory onto a roofing substrate.

In one embodiment, the adhesive material is applied to a lower surface of the substrate. In one embodiment, the adhesive material is applied to an upper surface of the substrate. In one embodiment, the adhesive material is applied to both a lower surface and an upper surface of the substrate.

In one embodiment, the method further comprises applying a release layer onto the adhesive material, to thereby cover the adhesive material with the release layer (see, e.g., FIG. 2).

In one embodiment, the primerless self-adhered roofing accessory can be prepared and/or manufactured in house or fabricated in the field prior to installation.

Yet another embodiment of this invention pertains to a method of installing at least one primerless self-adhered roofing accessory onto a roofing substrate that includes obtaining at least one primerless self-adhered roofing accessory, with the at least one primerless self- adhered roofing accessory comprising a substrate having an upper surface and a lower surface, with at least one of the upper surface or the lower surface of the substrate including an adhesive material, and applying the at least one primerless self-adhered roofing accessory to the roofing substrate. In one embodiment, the adhesive material is directly adhered to an upper surface of the roofing substrate.

In one embodiment, the method further comprises removing a release layer covering the adhesive material to thereby expose the adhesive material, prior to applying the at least one primerless self-adhered roofing accessory to the roofing substrate.

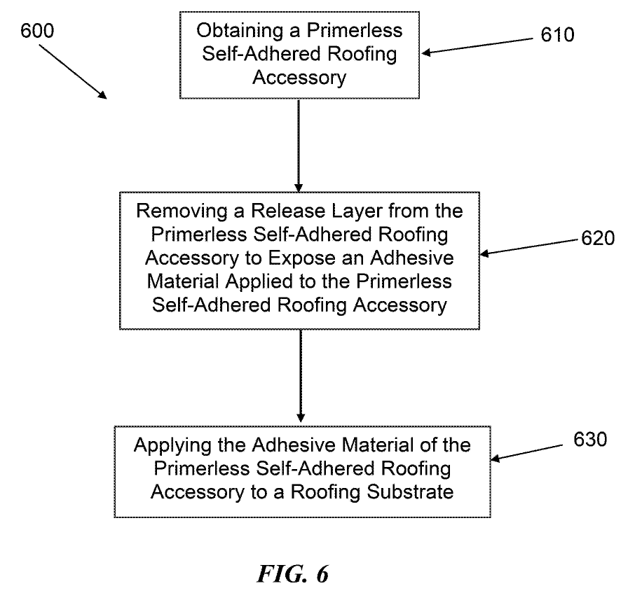

For example, FIG. 6 is a flowchart illustrating a method of installing a primerless self- adhered roofing accessory according to an embodiment of the invention. As shown in FIG. 6, the method 600 of installing a primerless self-adhered roofing accessory includes a step 610 of obtaining a primerless self-adhered roofing accessory, a step 620 of removing a release layer from the primerless self-adhered roofing accessory to expose an adhesive material applied to the primerless self-adhered roofing accessory, and a step 630 of applying the adhesive material of the primerless self-adhered roofing accessory to a roofing substrate.

In one embodiment, the applying the at least one primerless self-adhered roofing accessory to the roofing substrate is conducted without the use of a primer.

In one embodiment, the roofing substrate comprises an unprimed surface.

In one embodiment, the lower surface of the substrate includes the adhesive material. In one embodiment, the upper surface of the substrate includes the adhesive material. In one embodiment, both the lower surface and the upper surface of the substrate includes the adhesive material.

Another embodiment of this invention pertains to a bundle of primerless self-adhered roofing accessories that includes a plurality of primerless self-adhered roofing accessories, with each primerless self-adhered roofing accessory of the plurality of primerless self-adhered roofing accessories comprising a substrate having an upper surface and a lower surface, with at least one of the upper surface or the lower surface of the substrate including an adhesive material. In one embodiment, each primerless self-adhered roofing accessory of the plurality of primerless self-adhered roofing accessories is configured to be installed onto a roofing substrate without the use of a primer.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A roofing accessory comprising:
a substrate having an upper surface and a lower surface;
an adhesive material applied to at least one of the upper surface or the lower surface of the substrate; and
a release layer applied to the adhesive material,
wherein the roofing accessory is configured to be installed onto a roofing substrate without the use of a primer.

2. The roofing accessory according to claim 1, wherein the adhesive material is configured to directly adhere the roofing accessory to the roofing substrate.

3. The roofing accessory according to claim 1, wherein the lower surface of the substrate includes the adhesive material.

4. The roofing accessory according to claim 1, wherein the adhesive material comprises a butyl-based adhesive.

5. The roofing accessory according to claim 1, wherein the roofing accessory is in the form of a cover tape.

6. The roofing accessory according to claim 1, wherein the roofing accessory is in the form of a roll.

7. The roofing accessory according to claim 1, wherein the substrate comprises at least one of thermoplastic polyolefin (TPO), ethylene propylene diene monomer (EPDM), thermoplastic vulcanizates (TPV), polyvinyl chloride (PVC), or a combination thereof.

8. A roofing system comprising:
a roofing substrate having an upper surface and a lower surface; and
a roofing accessory attached to the upper surface of the roofing substrate, with the roofing accessory comprising:
a substrate having an upper surface and a lower surface; and
an adhesive material applied to at least one of the upper surface or the lower surface of the substrate,
wherein the roofing system does not include a primer layer located between the adhesive material of the roofing accessory and the upper surface of the roofing substrate, such that the adhesive material of the roofing accessory is directly adhered to the upper surface of the roofing substrate.

9. The roofing system according to claim 8, wherein the roofing accessory is attached to the roofing substrate without the use of a primer.

10. The roofing system according to claim 8, wherein the roofing substrate comprises an unprimed surface.

11. The roofing system according to claim 8, wherein the lower surface of the substrate of the roofing accessory includes the adhesive material.

12. The roofing system according to claim 8, wherein the adhesive material comprises a butyl-based adhesive.

13. The roofing system according to claim 8, wherein the substrate of the roofing accessory comprises at least one of thermoplastic polyolefin (TPO), ethylene propylene diene monomer (EPDM), thermoplastic vulcanizates (TPV), polyvinyl chloride (PVC), or a combination thereof.

14. The roofing system according to claim 8, wherein the roofing substrate comprises at least one of TPO, EPDM, PVC, metal, or a combination thereof.

15. A method comprising:
obtaining at least one roofing accessory, with the at least one roofing accessory comprising:
a substrate having an upper surface and a lower surface;
an adhesive material applied to at least one of the upper surface or the lower surface of the substrate; and
a release layer applied to the adhesive material; and
applying the at least one roofing accessory to a roofing substrate,wherein the adhesive material is directly adhered to an upper surface of the roofing substrate.

16. The method according to claim 15, wherein the applying the at least one roofing accessory to a roofing substrate is conducted without the use of a primer.

17. The method according to claim 15, further comprising removing the release layer applied to the adhesive material to thereby expose the adhesive material, prior to the applying the at least one roofing accessory to a roofing substrate.

18. The method according to claim 15, wherein the adhesive material comprises a butyl- based adhesive.

19. The method according to claim 15, wherein the substrate of the at least one roofing accessory comprises at least one of thermoplastic polyolefin (TPO), ethylene propylene diene monomer (EPDM), thermoplastic vulcanizates (TPV), polyvinyl chloride (PVC), or a combination thereof.

20. The method according to claim 15, wherein the roofing substrate comprises at least one of TPO, EPDM, PVC, metal, or a combination thereof.
